(19) United States
(12) Patent Application Publication
(10) Pub. No.: US 2022/0410393 A1
(43) Pub. Date: Dec. 29, 2022

(54) Method of Controlling Industrial Actuator, Control System and Actuator System

(71) Applicant: ABB Schweiz AG, Baden (CH)

(72) Inventors: Mikael Norrlöf, Norrköping (SE); Markus Enberg, Västerås (SE); Morten Åkerblad, Västerås (SE); Anders Spaak, Göteborg (SE)

(21) Appl. No.: 17/756,543

(22) PCT Filed: Dec. 4, 2019
(86) PCT No.: PCT/EP2019/083647

§ 371 Date: May 26, 2022

(51) Int. Cl. B25J 9/16

(52) U.S. Cl. CPC B25J 9/1664

(57) ABSTRACT

A method of controlling an industrial actuator, the method including providing a plurality of consecutive input target points, of which at least one is an intermediate input target point; for one or more of the at least one intermediate input target point, defining at least one virtual target point associated with the intermediate input target point; for one or more of the at least one virtual target point, defining a blending zone associated with the virtual target point; and defining a movement path on the basis of the at least one virtual target point and the at least one blending zone. A control system is also provided.

### TECHNICAL FIELD

The present disclosure generally relates to an industrial actuator. In particular, a method of controlling an industrial actuator, a control system for controlling an industrial actuator, and an actuator system comprising a control system and an industrial actuator, are provided.

### BACKGROUND

A robot program typically comprises a plurality of programmed input target points for determining a movement path of a tool center point (TCP) or a distal end of a manipulator of an industrial robot. The robot program can determine a fully defined movement path between consecutive input target points, for example by assuming a linear interpolation of consecutive movement segments between the input target points. The movement segments may be said to constitute the building blocks for the movement path.

It is previously known to define a blending zone associated with one or more input target points of the movement path. By defining a blending zone around an intermediate input target point, the intermediate input target point is never attained when executing the movement path since the direction of motion is changed before the intermediate input target point is reached.

A high accuracy movement path is typically generated by using close input target points with small blending zones. The sizes of the blending zones are chosen to keep the accuracy within a specified accuracy.

By increasing the size of a blending zone around an associated input target point in the program, the smoothness of the movement path can be increased. However, when a size of a blending zone is increased, the distance between the movement path and the input target point will also increase, i.e. the movement path becomes less accurate.

US 2019101888 A1 discloses a numerical controller that creates a tool path from a plurality of command points. The numerical controller includes a command point sequence acquisition unit that acquires an existing command point sequence; a command point creating unit that creates at least one additional command point, based on the existing command point sequence; and an interpolation processing unit that interpolates the existing command point sequence and the additional command point to create the tool path.

The command point creating unit outputs, as the additional command point, an intersection point between an arc passing through consecutive three command points in the existing command point sequence and a perpendicular bisector of a line segment.

### SUMMARY

One object of the present disclosure is to provide a method of controlling an industrial actuator, which method provides both smooth and accurate motion of the industrial actuator.

A further object of the present disclosure is to provide a method of controlling an industrial actuator, which method reduces wear of the industrial actuator.

A further object of the present disclosure is to provide a method of controlling an industrial actuator, which method improves performance of the industrial actuator.

A further object of the present disclosure is to provide a method of controlling an industrial actuator, which method is simple to use and/or implement.

A still further object of the present disclosure is to provide a method of controlling an industrial actuator, which solves several or all of the foregoing objects in combination.

A still further object of the present disclosure is to provide a control system for controlling an industrial actuator, which control system solves one, several or all of the foregoing objects.

A still further object of the present disclosure is to provide an actuator system comprising a control system and an industrial actuator, which actuator system solves one, several or all of the foregoing objects.

According to one aspect, there is provided a method of controlling an industrial actuator, the method comprising providing a plurality of consecutive input target points, of which at least one is an intermediate input target point; for one or more of the at least one intermediate input target point, defining at least one virtual target point associated with the intermediate input target point; for one or more of the at least one virtual target point, defining a blending zone associated with the virtual target point; and defining a movement path on the basis of the at least one virtual target point and the at least one blending zone.

The method may further comprise executing the movement path by the industrial actuator. The movement path defined on the basis of the at least one virtual target point and the at least one blending zone may alternatively be said to comprise the at least one virtual target point and the at least one blending zone.

By means of the at least one virtual target point, the method enables generation and execution of a smooth movement path that can pass through the input target points, or that increases accuracy with respect to the input target points. When executing the movement path, a deviation between the industrial actuator and the at least one intermediate input target point, with which at least one virtual target point is associated, is reduced. The method 3o thus enables creation and execution of smooth movement paths with high geometric accuracy. This in turn results in higher performance and process quality due to reduced accelerations of the industrial actuator. Reduced accelerations will also reduce wear and increase lifetime of the industrial actuator.

Each of the at least one virtual target point may be defined such as to reduce or eliminate a deviation between the industrial actuator and the intermediate input target point when executing a movement path by the industrial actuator, for example in comparison with a movement path comprising the input target points and a blending zone associated with each intermediate input target point.

Throughout the present disclosure, the virtual target points may alternatively be referred to as fake target points. With “fake” or “virtual” is meant that these target points are not necessarily intended to be reached by the industrial actuator. Rather, the fake or virtual target points are introduced as guidance for the industrial actuator to reach, or come closer to, the input target points with a smooth movement path.

The method may employ an algorithm where the input target points are input to the algorithm. Based on the input target points, the algorithm may define the at least one virtual target point, define the blending zone associated with the virtual target point for one or more of the at least one virtual target point, and define the movement path on the basis of the at least one virtual target point and the at least one blending zone. The algorithm may output the movement path for execution by the industrial actuator. The algorithm may be executed automatically based on a set of input target points and output the movement path.

At least one of the input target points may not be on a straight line between adjacent input target points. The input target points may be programmed positions in a program for the industrial actuator, e.g. a robot program. The input target points may be generated manually or automatically, e.g. 3o manually programmed by means of lead through programming or automatically generated from a CAD (computer-aided design) model. Further ways to generate the input target points are possible.

The method may further comprise defining movement segments between the virtual target points and at least some input target points, for example a starting input target point and an end input target point.

The movement segments may be defined by means of interpolation between two consecutive target points of the movement path. The interpolation can be made with different types of Cartesian base functions, such as lines, circle segments and splines. Also an interpolation in joint coordinates of the industrial actuator and/or an interpolation for tool orientation (for a tool of the industrial actuator) is possible.

Each blending zone is used to specify how a first of two consecutive movement segments is to be terminated and how a second of the two consecutive movement segments is to be initiated, i.e. how close to a target point between the two consecutive movement segments the industrial actuator must be before moving towards the next target point.

The blending zones may be two-dimensional or three-dimensional. The movement path may be two-dimensional or three-dimensional.

The method may be carried out with only three input target points, i.e. with a starting input target point, an intermediate input target point and an end input target point. Alternatively, or in addition, the method may be carried out with only one virtual target point. Alternatively, or in addition, the method may be carried out with a plurality of virtual target points where only one virtual target point is associated with each intermediate input target point.

The three input target points and the at least one virtual target point do not have to lie in a single plane. In case the method is carried out with four or more input target points, the input target points may or may not lie in a single plane.

According to one variant, the movement path does not comprise the at least one intermediate input target point, with which at least one virtual target point is associated. However, the movement path can still pass through the intermediate input target points.

For example, the movement path may comprise a starting input target point at the beginning of the movement path, an end input target point at the end of the movement path, the virtual target points between the starting input target point and the end input target point, but none of the intermediate input target points.

As used herein, a point between a first target point and a second target point may lie between a first plane in the first target point and a second plane in the second target point, where the first plane and the second plane are perpendicular to a straight line between the first target point and the second target point.

Each virtual target point may be defined between a preceding input target point and a succeeding input target point with respect to the input target point with which the respective virtual target point is associated. For example, if one virtual target point is associated with a second input target point between a first input target point and a third input target point (with no further input target points between the first input target point and the third input target point), the virtual target point may lie between the first input target point and the third input target point.

The definition of at least one virtual target point may comprise, for at least one intermediate input target point, defining a preceding virtual target point and a succeeding virtual target point associated with the intermediate input target point. For example, if a preceding virtual target point and a succeeding virtual target point are associated with a second input target point between a first input target point and a third input target point, the preceding virtual target point may lie between the first input target point and the second input target point, and the succeeding virtual target point may lie between the second input target point and the third input target point.

For the at least one intermediate input target point, the preceding virtual target point and the succeeding virtual target point may be defined such that the associated intermediate input target point is positioned on a straight line between the preceding virtual target point and the succeeding virtual target point.

The terminology “preceding” and “succeeding” is used to indicate that when the industrial actuator executes the movement path, the industrial actuator passes (not necessarily through) the preceding virtual target point before the succeeding virtual target point. The preceding virtual target point and the succeeding virtual target point may thus be positioned before and after, respectively, the associated input target point with respect to the movement path.

For each intermediate input target point with which a preceding virtual target point and a succeeding virtual target point are associated, the preceding virtual target point may be defined by a preceding virtual target vector from the input target point, and the succeeding virtual target point may be defined by a succeeding virtual target vector from the input target point, inverse to the preceding virtual target vector. In this way, both the preceding virtual target point and the succeeding virtual target point are positioned on a sphere centered in the associated input target point.

The definition of at least one virtual target point may comprise, for at least two intermediate input target points, defining a preceding virtual target point and a succeeding virtual target point associated with the intermediate input target point. Also in this case, for each intermediate input target point with which a preceding virtual target point and a succeeding virtual target point are associated, the preceding virtual target point may be defined by a preceding virtual target vector from the input target point and the succeeding virtual target point may be defined by a succeeding virtual target vector from the input target point, inverse to the preceding virtual target vector.

A sum of a length of a projection of the preceding virtual target vector from a succeeding input target point on a straight line between the succeeding input target point and a preceding input target point, and a length of a projection of the succeeding virtual target vector from the preceding input target point on the straight line may be equal to or less than a length of the straight line. For example, a projection of a preceding virtual target vector from a second input target point on a straight line between the second input target point and a first input target point, and a length of a projection of the succeeding virtual target vector from the first input target point on the straight line may be equal to or less than a length of the straight line between the first input target point and the second input target point.

Throughout the present disclosure, a straight line between two adjacent input target points may be referred to as a virtual movement segment. The prefix “virtual” is here used since the method does not necessarily employ movement segments between the input target points. However, movement segments between virtual target points, and between one input target point and one virtual target point, may be used.

The virtual target points may be defined such that a sum of each distance between each pair of a succeeding virtual target point of a preceding input target point and a preceding virtual target point of a succeeding input target point is minimized. For example, in case a preceding virtual target point and a succeeding virtual target point are associated with each of a first, second and third input target point, the virtual target points may be defined such that a sum of a distance between the succeeding virtual target point of the first input target point and the preceding virtual target point of the second input target point, and a distance between the succeeding virtual target point of the second input target point and the preceding virtual target point of the third input target point, is minimized.

An inclination of an intermediate vector, between a succeeding virtual target point associated with a preceding input target point and a preceding virtual target point associated with a succeeding input target point, may lie between an inclination of a succeeding virtual target vector between the preceding input target point and the succeeding virtual target point, and an inclination of a preceding virtual target vector between the preceding virtual target point and the succeeding input target point. The intermediate vector may thus lie in a cone defined by the two virtual target vectors.

A succeeding virtual target point associated with a preceding input target point and a preceding virtual target point associated with a succeeding input target point may be replaced by a single virtual target point if a distance between the succeeding virtual target point and the preceding virtual target point is below a threshold value. The replacing virtual target point may for example be either the succeeding virtual target point, the preceding virtual target point, or an average point between the succeeding virtual target point and the preceding virtual target point.

By replacing two virtual target points with a single virtual target point, the method can be made less computationally heavy. Furthermore, it can be avoided that two target points are too close to each other and the movement path can be made more smooth.

The preceding virtual target point may be defined between a preceding input target point and the input target point with which the respective virtual target point is associated, and the succeeding virtual target point may be defined between a succeeding input target point and the input target point with which the respective virtual target point is associated. For example, if two virtual target points are associated with a second input target point that lies between a first and a third input target point, the preceding virtual target point may lie between the first and the second input target point, and the succeeding virtual target point may lie between the second and the third input target point.

The method may further comprise for each preceding virtual target point, limiting a distance between the preceding virtual target point, and a straight line between a preceding input target point and the input target point with which the preceding virtual target point is associated. Alternatively, or in addition, the method may further comprise for each succeeding virtual target point, limiting a distance between the succeeding virtual target point, and a straight line between a succeeding input target point and the input target point with which the succeeding virtual target point is associated.

The method does not need to comprise interpolations between all input target points. However, in case linear interpolations are made between all input target points, this variant of the method limits deviation between the movement path and the linear interpolations between the input target points. In other words, this aspect of the method enables restricting the movement path to a certain degree of similarity to a linearly interpolated movement path between the input target points.

A maximum distance between an input target point and a preceding virtual target point associated with the input target point may be limited based on a distance between the input target point and a preceding input target point. The maximum distance may for example be set to half the distance between the input target point and the preceding input target point. Alternatively, or in addition, a maximum distance between an input target point and a succeeding virtual target point associated with the input target point may be limited based on a distance between the input target point and a succeeding input target point. The maximum distance may for example be set to half the distance between the input target point and the succeeding input target point.

The blending zone associated with one or more of the at least one virtual target point may be asymmetric. By defining the blending zone independently, e.g. by determining the blending zone expressed independently in each of the two consecutive movement segments associated with the blending zone, a flexible definition of the blending zone is provided.

Instead of being limited by symmetry, the shapes of the blending zones according to the present disclosure are allowed to vary and to be asymmetric.

Independent definitions of blending zones are detailed in international patent application PCT/EP2018/068071 (filed on 4 Jul. 2018), the contents of which are hereby incorporated by reference in its entirety.

For two or more of the at least one intermediate input target point, at least one virtual target point associated with the intermediate input target point may be defined, a blending zone may be associated with each of two consecutive virtual target points of the at least two virtual target points, and a distance between the blending zones associated with the two consecutive virtual target points may be less than 25%, such as 0%, of a distance between the two consecutive virtual target points. In case the distance is 25%, blending is allowed along 75% of the distance between the two consecutive virtual target points. According to one example, the entire movement path is covered by blending zones.

Throughout the present disclosure, the industrial actuator may be an industrial robot. The industrial robot may be of any type according to the present disclosure.

According to a further aspect, there is provided a control system for controlling an industrial actuator, the control system comprising a data processing device and a memory having a computer program stored thereon, the computer program comprising program code which, when executed by the data processing device, causes the data processing device to perform the steps of providing a plurality of consecutive input target points, of which at least one is an intermediate input target point; for one or more of the at least one intermediate input target point, defining at least one virtual target point associated with the intermediate input target point; for one or more of the at least one virtual target point, defining a blending zone associated with the virtual target point; and defining a movement path on the basis of the at least one virtual target point and the at least one blending zone. The computer program may further comprise program code which, when executed by the data processing device, causes the data processing device to command the industrial actuator to execute the movement path. The computer program may further comprise program code which, when executed by the data processing device, causes the data processing device to perform, or command performance of, any step according to the present disclosure. The computer program may contain the algorithm according to the present disclosure.

According to a further aspect, there is provided an actuator system comprising a control system according to the present disclosure and an industrial actuator. The industrial actuator may be of any type according to the present disclosure, for example an industrial robot.

### BRIEF DESCRIPTION OF THE DRAWINGS

Further details, advantages and aspects of the present disclosure will become apparent from the following embodiments taken in conjunction with the drawings, wherein:

FIG. 1: schematically represents an actuator system comprising an industrial robot and a control system;

FIG. 2: schematically represents a plurality of input target points according to the prior art;

FIG. 3: schematically represents a movement path defined on the basis of blending zones associated with the input target points according to the prior art;

FIG. 4: schematically represents an alternative movement path comprising alternative blending zones associated with the input target points according the prior art;

FIG. 5: schematically represents the input target points and examples of virtual target points;

FIG. 6: schematically represents a movement path;

FIG. 7: schematically represents blending zones associated with the virtual target points;

FIG. 8: schematically represents alternative blending zones associated with the virtual target points;

FIG. 9: schematically represents one example of a limitation of the virtual target points;

FIG. 10: schematically represents a further example of a limitation of the virtual target points;

FIG. 11: schematically represents a further example of virtual target points;

FIG. 12: schematically represents a further example of virtual target points;

FIG. 13: schematically represents an intermediate vector between two virtual target points; and

FIG. 14: schematically represents an intermediate vector and a cone formed by two virtual target vectors.

### DETAILED DESCRIPTION

In the following, a method of controlling an industrial actuator, a control system for controlling an industrial actuator, and an actuator system comprising a control system and an industrial actuator, will be described. The same or similar reference numerals will be used to denote the same or similar structural features.

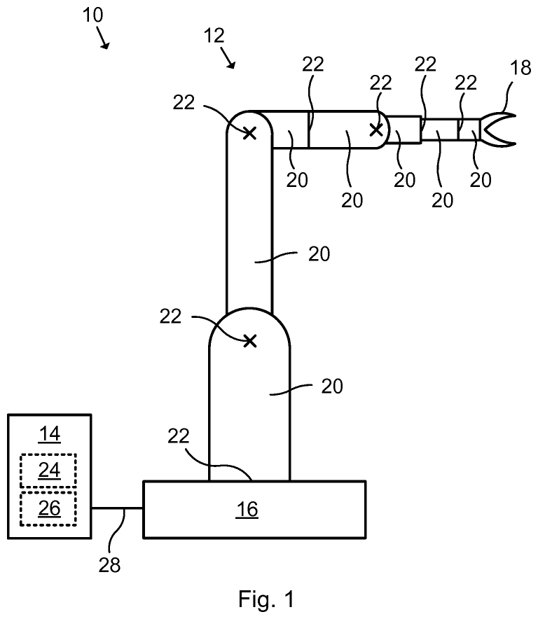

FIG. 1 schematically represents an actuator system 10 comprising an industrial actuator, here exemplified as an industrial robot 12, and a control system 14. The industrial robot 12 is exemplified as a seven axis industrial robot but the present disclosure is not limited to this type of industrial robot or industrial actuator. An industrial robot 12 according to the present disclosure may comprise at least three axes. The control system 14 is here exemplified as a robot controller.

The industrial robot 12 of this example comprises a base member 16 and a tool 18. The industrial robot 12 further comprises seven link members 20. Each link member 20 is rotationally or translationally movable at a joint 22.

The control system 14 is configured to control the industrial robot 12. The control system 14 comprises a data processing device 24 (e.g. a central processing unit, CPU) and a memory 26. A computer program is stored in the memory 26. The computer program comprises program code which, when executed by the data processing device 24, causes the data processing device 24 to perform the steps, or to command performance of the steps, as described herein.

In the example of FIG. 1, the control system 14 is in communication with the industrial robot 12 by means of a signal line 28. The control system 14 may however alternatively be integrated inside the industrial robot 12.

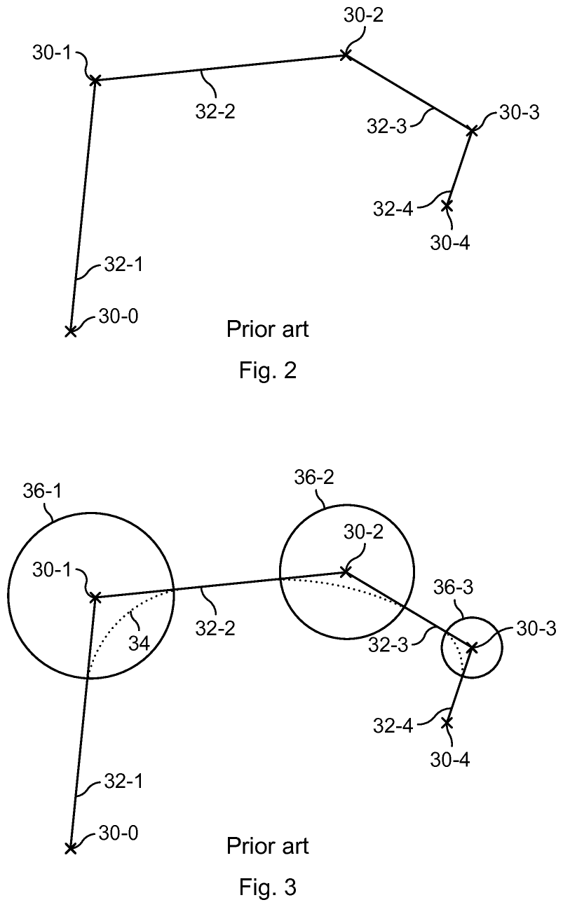

FIG. 2 schematically represents a plurality of input target points 30-0, 30-1, 30-2, 30-3 and 30-4 according to the prior art. The input target points 30-0, 30-1, 30-2, 30-3 and 30-4 may alternatively be referred to with reference numeral “30”. The input target points 30 may for example be generated by means of a software tool using the geometry of an application as input. As a further example, the input target points 30 may be manually programmed by means of lead through programming.

In FIG. 2, the input target point 30-0 is a starting input target point, the input target point 30-4 is an end input target point and each of the input target points 30-1, 30-2 and, 30-3 is an intermediate input target point. The input target points 30 are here illustrated in a single plane. However, the input target points 30 do not have to lie in a single plane. The input target points are used as input for creation of a movement path for the industrial robot 12.

The input target points 30 are interconnected by a plurality of movement segments 32-1, 32-2, 32-3 and 32-4. The movement segments 32-1, 32-2, 32-3 and 32-4 may alternatively be referred to with reference numeral “32”. Each movement segment 32 is defined between two input target points 30 such that each intermediate input target point 30-1, 30-2 and 30-3 is between two associated movement segments 32. The movement segments 32 of this example are linear interpolations between the two respective input target points 30.

FIG. 3 schematically represents a movement path 34 defined on the basis of the movement segments 32 and blending zones 36-1, 36-2 and 36-3 associated with the input target points 30 in FIG. 2. The blending zones 36-1, 36-2 and 36-3 may alternatively be referred to with reference numeral “36”. Also the movement path 34 defined on the basis of the blending zones 36 according to FIG. 3 belongs to the prior art. The movement path 34 in FIG. 3 is two-dimensional but may alternatively be three-dimensional.

The blending zone 36-1 is associated with the intermediate input target point 30-1, the blending zone 36-2 is associated with the intermediate input target point 30-2, and the blending zone 36-3 is associated with the intermediate input target point 30-3. Each blending zone 36 may be either two-dimensional or three-dimensional depending on the characteristics of the associated movement segments 32. The blending zones 36 in FIG. 3 are symmetric, i.e. circles or spheres.

A fine point (not illustrated) is associated with each of the starting input target point 30-0 and the end input target point 30-4. Fine points may alternatively be referred to as zero zones. Fine points are one type of stop points, meaning that the industrial robot 12 makes a full stop at these points. A stop point means that the industrial robot 12 must reach the specified position (stand still) before program execution continues with the next instruction.

During execution of the movement path 34 by the industrial robot 12 along a movement segment 32, when entering a blending zone 36, the movement path 34 will start to approach the succeeding movement segment 32. When leaving the blending zone 36, the movement path 34 will be along the succeeding movement segment 32. Thus, the industrial robot 12 (e.g. the TCP of the tool 18 thereof) will travel from the starting input target point 30-0 and along the movement segment 32-1 until the blending zone 36-1 is reached.

Within the blending zone 36-1, the movement segments 32-1 and 32-2 will be executed simultaneously (i.e. blended). When the industrial robot 12 leaves the blending zone 36-1, the industrial robot 12 will travel along the movement segment 32-2 until the blending zone 36-2 is reached. Within the blending zone 36-2, the movement segments 32-2 and 32-3 will be executed simultaneously. When the industrial robot 12 leaves the blending zone 36-2, the industrial robot 12 will travel along the movement segment 32-3 until the blending zone 36-3 is reached. Within the blending zone 36-3, the movement segments 32-3 and 32-4 will be executed simultaneously. When the industrial robot 12 leaves the blending zone 36-3, the industrial robot 12 will travel along the movement segment 32-4 until the end input target point 30-4 is reached.

In the example in FIG. 2, the intermediate input target points 30-1, 30-2 and 30-3 are fly-by points, meaning that these points are not attained when executing the movement path 34 by the industrial robot 12. Instead, the direction of motion is changed before any of the intermediate input target points 30-1, 30-2 and 30-3 is reached.

The smoothness of the resulting movement path 34 is limited by the distance between the input target points 30 and the sizes of the blending zones 36. As shown in FIG. 3, the movement path 34 does not pass through the intermediate input target points 30-1, 30-2, 30-3. The movement path 34 is somewhat smooth, but not very accurate since the distances between the movement path 34 and the intermediate input target points 30-1, 30-2, 30-3 are quite large. Therefore, with the approach in FIG. 3, the movement path 34 is guaranteed to not pass through the intermediate input target points 30 (except for an intermediate input target point positioned between two input target points on a straight line).

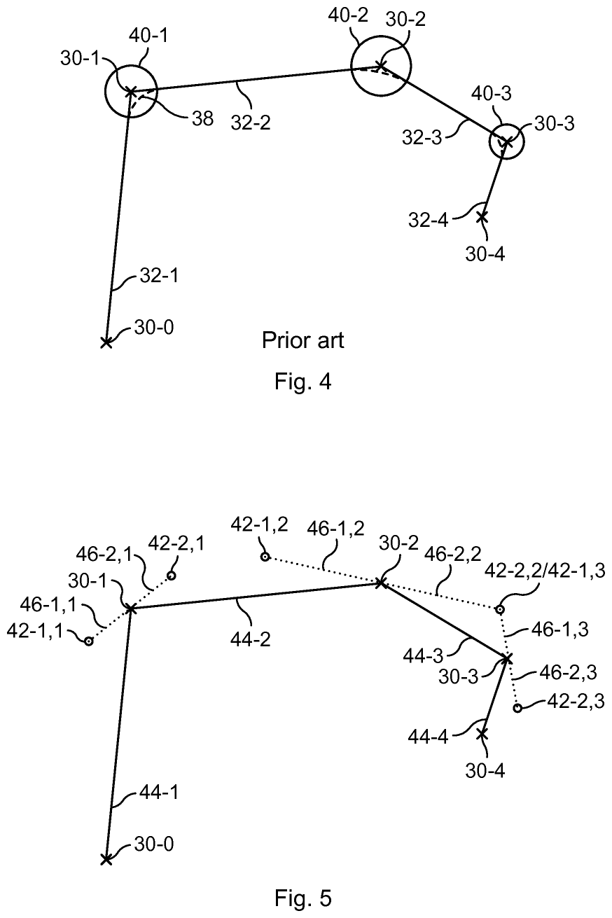

FIG. 4 schematically represents an alternative movement path 38 defined on the basis of the movement segments 32 and blending zones 40-1, 40-2 and 40-3 associated with the input target points 30 in FIG. 2. The blending zones 40-1, 40-2 and 40-3 may alternatively be referred to with reference numeral “40”. Also the movement path 38 defined on the basis of the blending zones 40 according to FIG. 4 belongs to the prior art. Mainly differences with respect to FIG. 3 will be described.

In FIG. 4, the sizes of the blending zones 40 are reduced to reduce deviations between the movement path 38 and the input target points 30. However, also the movement path 38 does not pass through the input target points 30.

The small blending zones 40 in FIG. 4 increase accelerations along the movement path 38, resulting in increased wear and tear on the industrial robot 12. The small blending zones 40 also cause speed reductions, which for example decrease processing quality in a processing operation. Increased accelerations occur because the industrial robot 12 needs to change moving directions in the blending zone 40. If the size of the blending zone 40 is small, the movement change needs to be more abrupt.

If a dynamic optimization of a trajectory along the movement path 38 is performed to get the shortest cycle time, and there are limitations on the acceleration, torque or other acceleration dependent parameters, a higher acceleration could cause a speed reduction in the blending zones 40. The speed reduction increases the cycle time and reduces the quality for applications requiring constant speed.

As shown in FIG. 4, the movement path 38 is more accurate in comparison with the movement path 34 in FIG. 3. That is, the distances between the movement path 38 and the intermediate input target points 30-2, 30-3, 30-4 are smaller. However, the movement path 38 is not smooth since the blending zones 40 are rather small. Thus, there are quite long distances between neighboring blending zones 40 where the movement path 38 has to follow the movement segments 32.

Thus, by making the blending zones larger, smoothness of the movement path is increased at the cost of accuracy of the movement path. By making the blending zones smaller, accuracy of the movement path is increased at the cost of smoothness of the movement path.

FIG. 5 schematically represents the input target points 30 and examples of virtual target points 42-1,1, 42-2,1, 42-1,2, 42-2,2 42-1,3 and 42-2,3 according to the present disclosure. The virtual target points 42-1,1, 42-2,1, 42-1,2, 42-2,2 42-1,3 and 42-2,3 may alternatively be referred to with reference numeral “42”. Also in FIG. 5, the input target points 30 are used as input for a movement path. However, instead of interpolating movement segments between the input target points 30, the virtual target points 42 are defined.

In FIG. 5, the input target points 30 are illustrated as interconnected by a plurality of straight lines 44-1, 44-2, 44-3 and 44-4. The straight lines 44-1, 44-2, 44-3 and 44-4 may alternatively be referred to with reference numeral “44”. Each straight line 44 is defined between two input target points 30 such that each intermediate input target point 30-1, 30-2 and 30-3 is between two straight lines 44. The straight lines 44 may alternatively be referred to as virtual movement segments. In some examples, the straight lines 44 are used to define the virtual target points 42 and/or blending zones. In some examples, the straight lines 44 are not needed.

The virtual target points 42-1,1 and 42-2,1 are associated with the input target point 30-1, the virtual target points 42-1,2 and 42-2,2 are associated with the input target point 30-2, and the virtual target points 42-1,3 and 42-2,3 are associated with the input target point 30-3. The virtual target points 42-1,1 and 42-2,1 lie between the input target points 30-0 and 30-2, the virtual target points 42-1,2 and 42-2,2 lie between the input target points 30-1 and 30-3, and the virtual target points 42-1,3 and 42-2,3 lie between the input target points 30-2 and 30-4.

The virtual target points 42-1,1, 42-1,2 and 42-1,3 are preceding virtual target points to the input target points 30-1, 30-2 and 30-3, respectively. The virtual target points 42-2,1, 42-2,2 and 42-2,3 are succeeding virtual target points to the input target points 30-1, 30-2 and 30-3, respectively.

The preceding virtual target point 42-1,1 is defined between the input target points 30-0 and 30-1, the preceding virtual target point 42-1,2 is defined between the input target points 30-1 and 30-2, and the preceding virtual target point 42-1,3 is defined between the input target points 30-2 and 30-3. The succeeding virtual target point 42-2,1 is defined between the input target points 30-1 and 30-2, the succeeding virtual target point 42-2,2 is defined between the input target points 30-2 and 30-3, and the succeeding virtual target point 42-2,3 is defined between the input target points 30-3 and 30-4.

To this end, a maximum distance between the input target point 30-1 and the preceding virtual target point 42-1,1 may be limited to not exceed a length of the straight line 44-1, and a maximum distance between the input target point 30-1 and the succeeding virtual target point 42-2,1 may be limited to not exceed a length of the straight line 44-2. A maximum distance between the input target point 30-2 and the preceding virtual target point 42-1,2 may be limited to not exceed a length of the straight line 44-2, and a maximum distance between the input target point 30-2 and the succeeding virtual target point 42-2,2 may be limited to not exceed a length of the straight line 44-3. A maximum distance between the input target point 30-3 and the preceding virtual target point 42-1,3 may be limited to not exceed a length of the straight line 44-3, and a maximum distance between the input target point 30-3 and the succeeding virtual target point 42-2,3 may be limited to not exceed a length of the straight line 44-4.

FIG. 5 further shows a plurality of virtual target vectors 46-1,1, 46-2,1, 46-1,2, 46-2,2, 46-1,3 and 46-2,3. The virtual target vectors 46-1,1, 46-2,1, 46-1,2, 46-2,2, 46-1,3 and 46-2,3 may alternatively be referred to with reference numeral “46”.

The preceding virtual target point 42-1,1 is defined by a preceding virtual target vector 46-1,1 from the input target point 30-1, the succeeding virtual target point 42-2,1 is defined by a succeeding virtual target vector 46-2,1 from the input target point 30-1, the preceding virtual target point 42-1,2 is defined by a preceding virtual target vector 46-1,2 from the input target point 30-2, the succeeding virtual target point 42-2,2 is defined by a succeeding virtual target vector 46-2,2 from the input target point 30-2, and the preceding virtual target point 42-1,3 is defined by a preceding virtual target vector 46-1,3 from the input target point 30-3, and the succeeding virtual target point 42-2,3 is defined by a succeeding virtual target vector 46-2,3 from the input target point 30-3. The preceding virtual target vector 46-1,1 is inverse to the succeeding virtual target vector 46-2,1, the preceding virtual target vector 46-1,2 is inverse to the succeeding virtual target vector 46-2,2, and the preceding virtual target vector 46-1,3 is inverse to the succeeding virtual target vector 46-2,3.

A sum of a length of a projection of the succeeding virtual target vector 46-2,1 on the straight line 44-2 and a projection of the preceding virtual target vector 46-1,2 on the straight line 44-2 is less than a length of the straight line 44-2. A sum of a length of a projection of the succeeding virtual target vector 46-2,2 on the straight line 44-3 and a projection of the preceding virtual target vector 46-1,3 on the straight line 44-3 is equal to the length of the straight line 44-3.

The succeeding virtual target point 42-2,1 is defined between the input target point 30-1 and the preceding virtual target point 42-1,2, or at the preceding virtual target point 42-1,2, and the preceding virtual target point 42-1,2 is defined between the succeeding virtual target point 42-2,1 and the input target point 30-2, or at the succeeding virtual target point 42-2,1. The succeeding virtual target point 42-2,2 is defined between the input target point 30-2 and the preceding virtual target point 42-1,3, or at the preceding virtual target point 42-1,3 (which is the case in FIG. 5), and the preceding virtual target point 42-1,3 is defined between the succeeding virtual target point 42-2,2 and the virtual target point 42-3, or at the succeeding virtual target point 42-2,2.

The method may employ an algorithm where the input target points 30 are input to the algorithm. Based on the input target points 30, the algorithm may define the at least one virtual target point 42.

In the following, one example of an algorithm for the method will be described. The algorithm may be implemented in the computer program in the control system 14. The algorithm uses the input target points 30 as input. A first step 1.1 of the algorithm of this example may be formulated as:

Providing a plurality of input target points pᵢ, i=0 . . . N, where N is a positive natural number of at least 2 (1.1)

A subsequent step 1.2 of the algorithm of this example may be formulated as:

for each input target point pᵢ, i=[1, . . . , N−1], introduce two virtual target points p_{v1,i}=pᵢ+υᵢ and p_{v2,i}=pᵢ−υᵢ, where υi are the virtual target vectors 46. (1.2)

A subsequent step 1.3 of the algorithm of this example may be formulated as:

Find υᵢ in step 1.2 such that Σᵢ₌₁^{N-2}∥p_{v2,i}−p_{v1,i+1}∥² is minimized (1.3)

In this way, a sum of distances between adjacent virtual target points 42 associated with different input target points 30 can be minimized. With reference to FIG. 5, the sum of a distance between the succeeding virtual target point 42-2,1 and the preceding virtual target point 42-1,2 and a distance between the succeeding virtual target point 42-2,2 and the preceding virtual target point 42-1,3 is minimized.

In this example, υᵢ is the objective function of the optimization problem in step 1.3. A parametrization of υᵢ may be used to solve the optimization problem.

In order to understand step 1.3, one may think of a describing analogy where rubber bands are positioned around two adjacent virtual target points 42 pulling these together. For example, it may be thought of one rubber band pulling the virtual target points 42-2,1 and 42-1,2 together, and one rubber band pulling the virtual target points 42-2,2 and 42-1,3 together. It may further be thought of one rubber band pulling the input target point 30-0 and the virtual target point 42-1,1 together, and one rubber band pulling the input target point 30-4 and the virtual target point 42-2,3 together. The objective function would then be to minimize tension in the rubber bands.

Step 1.3 constitutes one example of defining a plurality of virtual target points 42 such as to reduce a deviation between the industrial robot 12 and the intermediate input target point 30-1, 30-2 and 30-3 when executing a movement path by the industrial robot 12.

A subsequent step 1.4 of the algorithm of this example may be formulated as:

For all virtual target points 42 where ∥p_{v2,i}−p_{v1,i+1}∥²<ε², the two virtual target points 42 are replaced by the average, p̅ᵥᵢ (1.4)

where ε is a threshold value. The threshold value c may for example be set based on an average length of the straight lines 44. In FIG. 5, the virtual target points 42-2,2 and 42-1,3 are close to each other and are therefore replaced by a single virtual target point 42-2,2/42-1,3, for example the average of the virtual target points 42-2,2 and 42-1,3. In this way, the number of virtual target points 42 can be reduced. The method can thereby be made less computationally heavy. Furthermore, it can be avoided that two target points are too close to each other.

In a subsequent step, the algorithm may define a blending zone associated with one or more of the virtual target points 42, such as for each virtual target point 42. The sizes of the blending zones may be maximized such that the entire movement path is covered by blending zones.

The result from the algorithm is a movement path defined on the basis of the starting input target point 30-0, the end input target point 30-4, the virtual target points 42, and the blending zones associated with the virtual target points 42. The movement path is defined on the basis of the input target points 30-0, 30-4 and five virtual target points 42. The movement path of this example does however not comprise the intermediate input target point 30-1, 30-2 and 30-3, with which the virtual target points 42 are associated. Thus, the movement path comprises seven target points, which is an increase with only two target points from the five input target points 30. The movement path is therefore only slightly more computationally heavy than the movement paths 34 and 38.

The movement path can then be implemented in a program for the industrial robot 12 and be executed by the industrial robot 12. The algorithm may be executed automatically based on a set of input target points 30 and output the movement path.

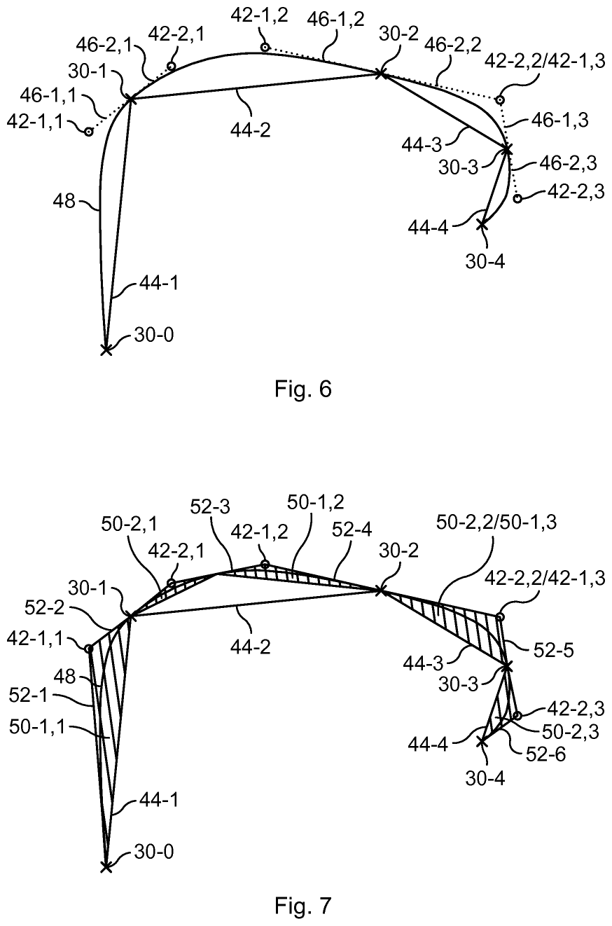

FIG. 6 schematically represents the resulting movement path 48 generated by the algorithm using the input target points 30 as input. The movement path 48 comprises the start input target points 30-0, the end input target point 30-4, the virtual target points 42 and a blending zone associated with each virtual target point 42. Fine points are applied to the start input target point 30-0 and to the end input target point 30-4. The blending zones may be defined in various ways.

As shown in FIG. 6, the method enables the movement path 48 to pass through each intermediate input target point 30-1, 30-2 and 30-3. The virtual target points 42 further enable maximum smoothness of the movement path 48 to be achieved. The movement path 48 in FIG. 6 is both smoother than the movement path 34 in FIG. 3 and more accurate than the movement path 38 in FIG. 4. The smoothness of the movement path 48 enables a high speed trajectory along the movement path 48.

The method can be at least partly implemented in software tools, such as RobotStudio®. In this way, smooth and accurate movement paths 48 can be generated according to the method in a simple manner.

FIG. 7 schematically represents one example of blending zones 50-1,1, 50-2,1, 50-1,2, 50-2,2/50-1,3 and 50-2,3 associated with the virtual target points 42.

The blending zones 50-1,1, 50-2,1, 50-1,2, 50-2,2/50-1,3 and 50-2,3 may alternatively be referred to with reference numeral “50”.

The starting input target point 30-0 and the end input target point 30-4 of this example are fine points. Thus, zone borders are provided at the input target points 30-0 and 30-4. Zone borders are also provided at each intermediate input target point 30-1, 30-2 and 30-3. The zone border at each intermediate input target point 30-1, 30-2 and 30-3 may be defined as a plane perpendicular to the respective virtual target vectors 46. The zone border at the starting input target point 30-0 may be defined as a plane perpendicular to the associated straight line 44-1 and the zone border at the end input target point 30-4 may be defined as a plane perpendicular to the associated straight line 44-4.

As shown in FIG. 7, the blending zones 50 are maximized and asymmetric. In this example, each blending zone 50 is defined as a triangle with one line connecting respective zone borders, and two lines connecting a virtual target point 42 with a respective zone border.

FIG. 7 further shows a plurality of movement segments 52-1, 52-2, 52-3, 52-4, 52-5 and 52-6. The movement segments 52-1, 52-2, 52-3, 52-4, 52-5 and 52-6 may alternatively be referred to with reference numeral “52”. The method may further comprise defining movement segments 52 between the virtual target points 42 and some input target points 30, for example the starting input target point 30-0 and an end input target point 30-4.

In this example, each movement segment 52 is a linear interpolation between two associated target points. The movement segment 52-1 connects the input target point 30-0 and the virtual target point 42-1,1, the movement segment 52-2 connects the virtual target points 42-1,1 and 42-2,1, the movement segment 52-3 connects the virtual target points 42-2,1 and 42-1,2, the movement segment 52-4 connects the virtual target points 42-1,2 and 42-2,2/42-1,3, the movement segment 52-5 connects the virtual target points 42-2,2/42-1,3 and 42-2,3, and the movement segment 52-6 connects the virtual target point 42-2,3 and the input target point 30-4.

In FIG. 7, each blending zone 50 is defined independently in relation to the movement segments 52 associated with the blending zone 50. By defining the blending zones 50 independently, i.e. by determining the blending zones 50 expressed independently in each of the two consecutive movement segments 52 associated with the blending zones 50, a flexible definition of the blending zones 50 is provided. Instead of being limited by symmetry, the shapes of the blending zones 50 according to the present disclosure are allowed to vary and to be asymmetric.

The blending zone 50-1,1 is defined as a triangle comprising a line between the input target points 30-0 and 30-1, a line between the input target point 30-0 and the virtual target point 42-1,1 (here also the movement segment 52-1), and a line between the input target point 30-1 and the virtual target point 42-1,1. The blending zone 50-2,1 is defined as a triangle comprising a line between the input target point 30-1 and a zone border between (e.g. halfway between) the virtual target points 42-2,1 and 42-1,2, a line between the input target point 30-1 and the virtual target point 42-2,1, and a line between the zone border between the virtual target points 42-2,1 and 42-1,2 and the virtual target point 42-2,1. The blending zone 50-1,2 is defined as a triangle comprising a line between the zone border between the virtual target points 42-2,1 and 42-1,2 and the input target point 30-2, a line between the zone border between the input virtual target points 42-2,1 and 42-1,2 and the virtual target point 42-1,2, and a line between the input target point 30-2 and the virtual target point 42-1,2. The blending zone 50-2, 2/50-1,3 is defined as a triangle comprising a line between the input target points 30-2 and 30-3, a line between the input target point 30-2 and the virtual target point 42-2,2/42-1,3, and a line between the input target point 30-3 and the virtual target point 42-2,2/42-1,3. The blending zone 50-2,3 is defined as a triangle comprising a line between the input target points 30-3 and 30-4, a line between the input target point 30-3 and the virtual target point 42-2,3, and a line between the input target point 30-4 and the virtual target point 42-2,3 (here also the movement segment 52-6).

In this example, each blending zone 50 comprises two zone borders and each zone border is defined in relation to a respective one of the two movement segments 52 associated with the virtual target point 42. Each zone border may for example be defined with a percentage of between 0% and 100% in relation to each of the two consecutive movement segments 52.

In FIG. 7, the blending zone 50-1,1 extends from a preceding zone border at 100% of the preceding movement segment 52-1 from the virtual target point 42-1,1 to a succeeding zone border at 50% of the succeeding movement segment 52-2 from the virtual target point 42-1,1. The blending zone 50-2,1 extends from a preceding zone border at 50% of the preceding movement segment 52-2 from the virtual target point 42-2,1 to a second zone border at 50% of the succeeding movement segment 52-3 from the virtual target point 42-2,1. The blending zone 50-1,2 extends from a preceding zone border at 50% of the preceding movement segment 52-3 from the virtual target point 42-1,2 to a succeeding zone border at 50% of the succeeding movement segment 52-4 from the virtual target point 42-1,2. The blending zone 50-2,2/50-1,3 extends from a preceding zone border at 50% of the preceding movement segment 52-4 from the virtual target point 42-2,2/42-1,3 to a succeeding zone border at 50% of the succeeding movement segment 52-5 from the virtual target point 42-2,2/42-1,3. The blending zone 50-2,3 extends from a preceding zone border at 50% of the preceding movement segment 52-5 from the virtual target point 42-2,3 to a succeeding zone border at 50% of the succeeding movement segment 52-6 from the virtual target point 42-2,3.

As shown in FIG. 7, the blending zones 50 cover the entire movement path 48. Thus, a distance between the blending zones 50 associated with two consecutive virtual target points 42 is 0. Blending is consequently allowed along the entire movement path 48 between the input target points 30-0 and 30-4.

Alternatively, or in addition, each blending zone 50 may be defined with a factor from 0 to 1 in relation to each of the respective two consecutive movement segments 52. The factor may be constituted by an interpolation index that has the value 0 in the virtual target point 42 associated with the blending zone 50 and the value 1 in each adjacent target point.

Each blending zone 50 may be defined with a different percentage or factor in relation to each of the respective two consecutive movement segments 52. In case one or more points of the movement path 48 (in addition to the input target points 30-0 and 30-4) are fine points, at least one blending zone 50 associated with a virtual target point 42 may be defined as 100% of the movement segment 52 between the virtual target point 42 and the fine point. The same blending zone 50 may still be defined independently in relation to the other movement segment 52 associated with the blending zone 50.

The defined movement path 48 is the same regardless of speeds and accelerations of the industrial robot 12 along the movement path 48. The geometry of the movement path 48 is defined independently of the dynamics of the industrial robot 12. A dynamic coupling, e.g. speeds and accelerations of the industrial robot 12 along the movement path 48, may be generated in a further step to define a movement trajectory. The movement path 48 within the blending zones 50 may however be blended in various ways. Instead of curves, the movement path 48 may for example adopt various polynomial shapes within the blending zones 50. The movement path 48 within each blending zone 50 may be referred to as a corner path.

Due to the blending zones 50, the industrial robot 12 is allowed to fly-by the virtual target points 42. The movement path 48 is thereby made more smooth and acceleration and deceleration phases along the movement path 48 can be reduced or eliminated. As a consequence, the speed of the industrial robot 12 can be increased and the wear on mechanical components of the industrial robot 12 can be reduced.

In this example, the blending zones 50 are positioning blending zones 50, i.e. for positioning the tool 18. Additional orientation blending zones may be defined for orientation of the tool 18. Alternatively, the positioning blending zones 50 may be used also for orientation of the tool 18.

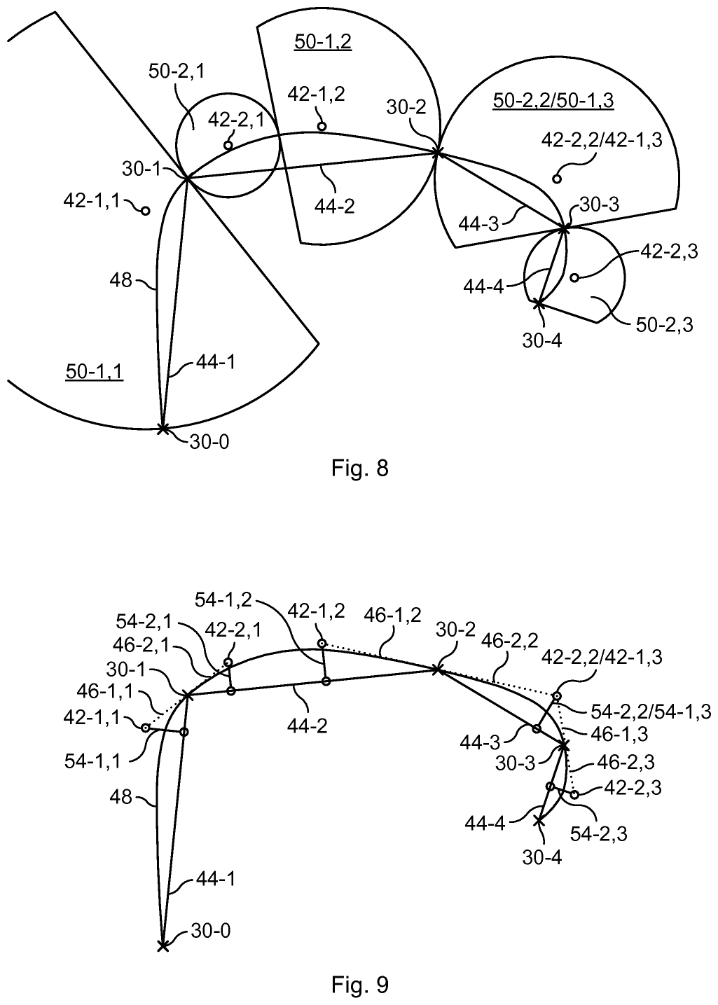

FIG. 8 schematically represents a further example of blending zones 50-1,1, 50-2,1, 50-1,2, 50-2,2/50-1,3 and 50-2,3 associated with the virtual target points 42. Mainly differences with respect to FIG. 7 will be described.

In FIG. 8, each blending zone 50 is a circle (or sphere in case of a three-dimensional movement path 48). For each blending zone 50, the circle is centered at the associated virtual target point 42.

The blending zone 50-1,1 is a partial circle centered at the input target point 30-1. The radius of the blending zone 50-1,1 corresponds to the distance between the input target point 30-0 and the virtual target point 42-1,1. The blending zone 50-1,1 is limited by a preceding zone border in the input target point 30-1.

The blending zone 50-2,1 is a full circle centered at the virtual target point 42-2,1. The radius of the blending zone 50-2,1 corresponds to the distance between the virtual target point 42-2,1 and the input target point 30-1.

The blending zone 50-1,2 is a partial circle centered at the virtual target point 42-1,2. The radius of the blending zone 50-1,2 corresponds to the distance between the virtual target point 42-1,2 and the input target point 30-2. The blending zone 50-1,2 is limited by the blending zone 50-2,1.

The blending zone 50-2,2/50-1,3 is a partial circle centered at the virtual target point 42-2,2/42-1,3. The radius of the blending zone 50-2,2/50-1,3 corresponds to the distance between the virtual target point 42-2,2/42-1,3 and the input target point 30-2. The blending zone 50-2,2/50-1,3 is limited by a zone border at the input target point 30-3.

The blending zone 50-2,3 is a partial circle centered at the virtual target point 42-2,3. The radius of the blending zone 50-2,3 corresponds to the distance between the virtual target point 42-2,3 and the input target point 30-3. The blending zone 50-2,3 is limited by a zone border at the input target point 30-4.

Also in FIG. 8, the blending zones 50 are maximized and some of the blending zones 50 (all except blending zone 50-2,1) are asymmetric.

The orientation o_{1,i} of the tool 18 in the virtual target points 42 can be computed by computing the orientation from the input target points 30 using a slerp (spherical linear) interpolation with

$${o}_{1 , i} = slerp ( {o}_{i - 1} , {o}_{i} , L ) where {L}_{1 , i} = \frac{\vert {υ}_{i}^{T} ( {p}_{i - 1} {p}_{i} ) \vert}{‖ {p}_{i - 1} - {p}_{i} ‖}$$

o_{2,i} can be computed in a similar way. o_{1,i} and o_{2,i} are unit quaternions representing the orientation of the tool 18 in a normalized 4-element data vector. Using this approach and linear interpolation between the virtual target points 42, both the position and the orientation of the tool 18 in the input target points 30 will be correct in the movement path 48. Other types of interpolation schemes can of course be used to interpolate the orientation of the tool 18.

FIG. 9 schematically represents one example of a limitation of the virtual target points 42. FIG. 9 further shows a plurality of distances 54-1,1, 54-2,1, 54-1,2, 54-2,2/54-1,3 and 54-2,3. The distances 54-1,1, 54-2,1, 54-1,2, 54-2,2/54-1,3 and 54-2,3 may alternatively be referred to with reference numeral “54”.

The algorithm can be extended with additional constraints. An additional constraint 2.1 of the algorithm of this example may be formulated as:

The shortest distance 54 from the virtual target points p_{v1,i} with index i to the straight line lᵢ connecting the input target points pᵢ₋₁ and pᵢ is ≤εₜₒₗ, and the shortest distance 54 from the virtual target points p_{v2,i} with index i to the straight line lᵢ₊₁ connecting the input target points pᵢ and pᵢ₊₁ is ≤εₜₒₗ (2.1)

εₜₒₗ may for example be set to 1 mm. As shown in FIG. 9, distances between the respective preceding virtual target points 42-1,1, 42-1,2 and 54-2,2/54-1,3 and the respective straight lines 44-1, 44-2 and 44-3 are limited by the respective distances 54-1,1, 54-1,2, 54-2,2/54-1,3. Furthermore, distances between the respective succeeding virtual target points 42-2,1, 42-2,2/42-1,3 and 42-2,3 and the respective straight lines 44-2, 44-3 and 44-4 are limited by the respective distances 54-2,1, 54-2,2/54-1,3 and 54-2,3.

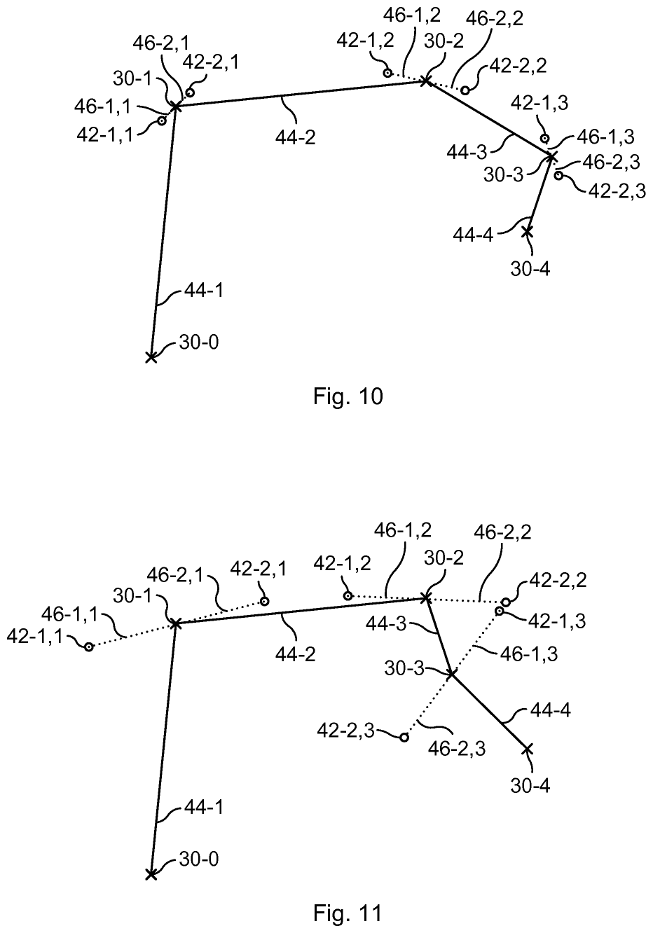

FIG. 10 schematically represents a further example of a limitation of the virtual target points 42. In FIG. 10, εₜₒₗ in constraint 2.1 is reduced in comparison with εₜₒₗ in FIG. 9. As a consequence, the virtual target points 42 are moved closer to their respectively associated input target point 30 and the deviations of the movement path 48 from the straight lines 44 between respective input target points 30 will be made smaller. In this way, the movement path 48 can be restricted to a certain degree of conformity with a linearly interpolated movement path between the input target points 30. However, the movement path 48 will be less smooth if εₜₒₗ is selected to a too low value.

FIG. 11 schematically represents a further example of virtual target points 42. The positions of the virtual target points 42-2,2 and 42-1,3 between the input target points 30-2 and 30-3 are close, but in this example not close enough to be replaced by a single virtual target point according to step 1.4.

An additional constraint 2.2 of the algorithm of this example may be formulated as:

∥υᵢ∥²≤min{∥pᵢ−pᵢ₋₁∥²,∥pᵢ₊₁−pᵢ∥²}/κ²,κ≥1 (2.2)

In this way, the positions of the virtual target points 42 are limited related to the distances between the input target points 30. κ thus represents how large part of a distance between two input target points 30 that can be utilized for positioning the virtual target points 42. In FIG. 11, κ is for example set to 1. The positions of the virtual target points 42 are thereby related to the distances between the input target points 30.

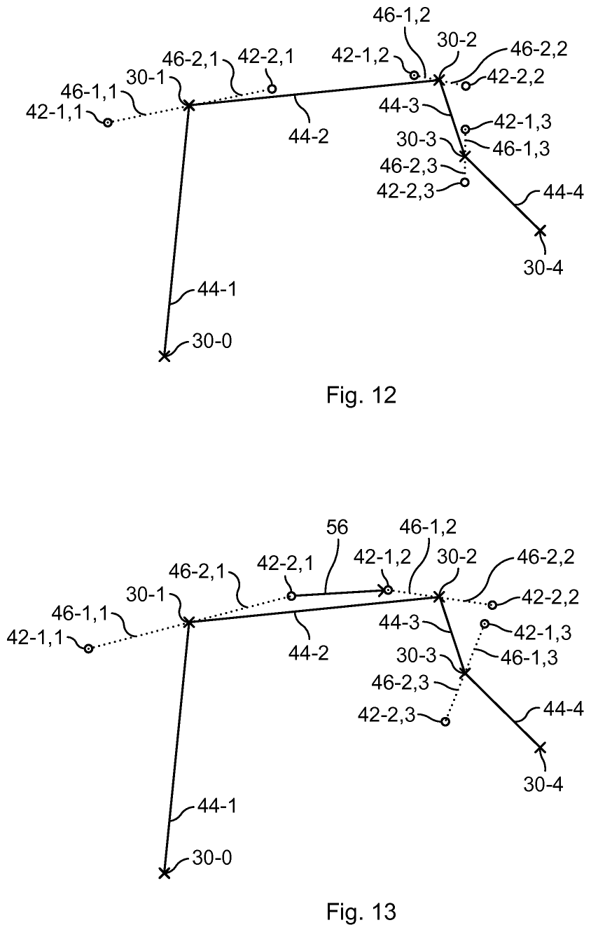

FIG. 12 schematically represents a further example of virtual target points 42. In FIG. 12, κ in constraint 2.2 is set to 3. As a consequence, the lengths of the virtual target vectors 46 are reduced and the movement path 48 is made more smooth between the input target points 30-2 and 30-3.

FIG. 13 schematically represents an intermediate vector 56 between the two virtual target points 42-1,2 and 42-1,2. An additional constraint (2.3) of the algorithm of this example may be formulated as:

The intermediate vector p_{v2,i}−p_{v1,i+1} between a succeeding virtual target point 42 of a preceding input target point 30 and a preceding virtual target point 42 of a succeeding input target point 30 should lie in a cone defined by υᵢ and υᵢ₊₁ (2.3)

The constraint 2.3 imposes smoothness. With constraint 2.3, movement changes in the movement path 48 will be improved since the virtual target vectors υᵢ and υᵢ₊₁ represent the direction (derivative) in the respective input target point pᵢ and pᵢ₊₁. As shown in FIG. 13, an inclination of the intermediate vector 56 lies between an inclination of the succeeding virtual target vector 46-2,1 and the preceding virtual target vector 46-1,2.

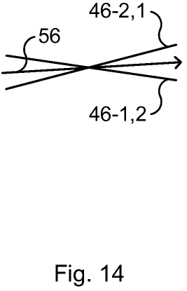

FIG. 14 schematically represents the intermediate vector 56 and a cone formed by the virtual target vectors 46-2,1 and 46-1,2. As illustrated in FIG. 14, constraint 2.3 puts a constraint on the intermediate vector 56 connecting the virtual target points 42-2,1 and 42-1,2 such that the intermediate vector 56 lies in a cone spanned by the virtual target vectors 46-1 and 46-2. By means of the intermediate vector 56 defined in this way, the movement path 48 can be made even more smooth.

Constraint 2.3 can be effectively expressed as c is inside if:

c^{-T}(ā+b̅)≥ā^{T}(ā+b̅)

This constraint also works in a three-dimensional implementation. The vectors used in the inequality are normalized.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A method of controlling an industrial actuator, the method comprising:
providing a plurality of consecutive input target points, of which at least one is an intermediate input target point;
for one or more of the at least one intermediate input target point, defining at least one virtual target associated with the intermediate input target point;
for one or more of the at least one virtual target point, defining a blending zone associated with the virtual target point; and
defining a movement path on the basis of the at least one virtual target point and the at least one blending zone.

2. The method according to claim 1, wherein the movement path does not include the at least one intermediate input target point, with which at least one virtual target point is associated.

3. The method according to claim 1, wherein each virtual target point is defined between a preceding input target point and a succeeding input target point with respect to the input target point with which the respective virtual target point is associated.

4. The method according to claim 1, wherein the definition of at least one virtual target point includes, for at least one intermediate input target point, defining a preceding virtual target point and a succeeding virtual target point associated with the intermediate input target point.

5. The method according to claim 4, wherein for each intermediate input target point with which a preceding virtual target point and a succeeding virtual target point are associated, the preceding virtual target point is defined by a preceding virtual target vector from the input target point and the succeeding virtual target point is defined by a succeeding virtual target vector from the input target point, inverse to the preceding virtual target vector.

6. The method according to claim 1, wherein the definition of at least one virtual target point includes, for at least two intermediate input target points, defining a preceding virtual target point and a succeeding virtual target point associated with the intermediate input target point.

7. The method according to claim 6, wherein for each intermediate input target point with which a preceding virtual target point and a succeeding virtual target point are associated, the preceding virtual target point is defined by a preceding virtual target vector from the input target point and the succeeding virtual target point is defined by a succeeding virtual target vector from the input target point, inverse to the preceding virtual target vector.

8. The method according to claim 7, wherein a sum of a length of a projection of the preceding virtual target vector from a succeeding input target point on a straight line between the succeeding input target point and a preceding input target point, and a length of a projection of the succeeding virtual target vector, from the preceding input target point on the straight line is equal to or less than a length of the straight line.

9. The method according to claim 6, wherein the virtual target points are defined such that a sum of each distance between each pair of a succeeding virtual target point of a preceding input target point and a preceding virtual target point of a succeeding input target point is minimized.

10. The method according to claim 6, wherein an inclination of an intermediate vector, between a succeeding virtual target point associated with a preceding input target point and a preceding virtual target point associated with a succeeding input target points, lies between an inclination of a succeeding virtual target vector between the preceding input target point and the succeeding virtual target point, and an inclination of a preceding virtual target vector between the preceding virtual target point and the succeeding input target point.

11. The method according to claim 6, wherein a succeeding virtual target point associated with a preceding input target point and a preceding virtual target point associated with a succeeding input target point are replaced by a single virtual target point if a distance between the succeeding virtual target point and the preceding virtual target point is below a threshold value.

12. The method according to claim 4, wherein the preceding virtual target point is defined between a preceding input target point and the input target point with which the respective virtual target point is associated, and wherein the succeeding virtual target point is defined between a succeeding input target point and the input target point with which the respective virtual target point is associated.

13. The method according to claim 4, further comprising for each preceding virtual target point limiting a distance between the preceding virtual target point, and a straight line between a preceding input target point and the input target point with which the preceding virtual target point is associated.

14. The method according to claim 4, wherein a maximum distance between an input target point and a preceding virtual target point associated with the input target point is limited based on a distance between the input target point and a preceding input target point.

15. The method according to claim 1, wherein the blending zone associated with one or more of the at least one virtual target point is asymmetric.

16. The method according to claim 1, wherein for two or more of the at least one intermediate input target point, at least one virtual target point associated with the intermediate input target point is defined, wherein a blending zone is associated with each of two consecutive virtual target points of the at least two virtual target points, and wherein a distance between the blending zones associated with the two consecutive virtual target points is less than 25% of a distance between the two consecutive virtual target points.

17. The method according to claim 1, wherein the industrial actuator is an industrial robot.

18. A control system for controlling an industrial actuator, the control system including a data processing device and a memory having a computer program stored thereon, the computer program comprising program code which, when executed by the data processing device-causes the data processing device to perform the steps of:
providing a plurality of consecutive input target points, of which at least one is an intermediate input target point;
for one or more of the at least one intermediate input target point, defining at least one virtual target point associated with the intermediate input target point;
for one or more of the at least one virtual target point, defining a blending zone associated with the virtual target point; and
defining a movement path on the basis of the at least one virtual target point and the at least one blending zone.

19. An actuator system comprising an industrial actuator and a control system for controlling the industrial actuator;
the control system including a data processing device and a memory having a computer program stored thereon, the computer program comprising program code which, when executed by the data processing device, causes the data processing device to perform the steps of:
providing a plurality of consecutive input target points, of which at least one is an intermediate input target point;
for one or more of the at least one intermediate input target point defining at least one virtual target point associated with the intermediate input target point;
for one or more of the at least one virtual target point, defining a blending zone associated with the virtual target point; and
defining a movement path on the basis of the at least one virtual target point and the at least one blending zone.
